(19) United States
(12) Patent Application Publication
(10) Pub. No.: US 2025/0076078 A1
(43) Pub. Date: Mar. 6, 2025

(54) METHOD, APPARATUS, AND COMPUTER PROGRAM PRODUCT FOR PATH ESTIMATION USING PREDICTIVE MODEL

(71) Applicant: HERE GLOBAL B.V., Eindhoven (NL)

(72) Inventor: Jani KAPPI, Tampere (FI)

(21) Appl. No.: 18/459,752

(22) Filed: Sep. 1, 2023

(51) Int. Cl. G01C 21/00; G01C 21/16

(52) U.S. Cl. CPC G01C 21/3844; G01C 21/16

(57) ABSTRACT

Provided herein is a method for estimating path likelihood using a predictive motion model. Methods may include: receiving sensor data from an inertial measurement unit associated with a vehicle; determining, from the sensor data, a motion model of the vehicle; retrieving one or more baseline motion models, where each baseline motion model corresponds to a path within an environment along one or more road segments; calculating relative transformations between the motion model of the vehicle and the one or more baseline motion models; identifying a predicted motion model of the one or more baseline motion models as corresponding to the vehicle motion model; and determining a path of the vehicle to correspond with the path within the environment corresponding to the predicted motion model.

### TECHNOLOGICAL FIELD

Example embodiments described herein relate generally to predicting a path to be taken along a route, and more particularly, to estimating path likelihood using a predictive motion model.

### BACKGROUND

Navigation technology has evolved substantially from the use of a compass, stars, and maps to find direction. Satellite navigation systems have revolutionized navigation. Global navigation satellite systems (GNSS) provide a mechanism by which a location can be discerned virtually anywhere in the world with a digital device that receives signals from satellites orbiting the Earth. Signals received from these satellites can provide localization of a device in many environments.

GNSS platforms, such as Global Positioning System (GPS) used in the US typically provides accurate location information to a GPS receiver based on signals from satellites. However, these systems suffer from some drawbacks. The accuracy of GNSS varies between the different types, and their accuracy changes based on environmental factors. Tree cover, urban canyons, buildings, and tunnels are some of the obstacles that negatively impact GNSS accuracy. As such, while GNSS localization is desirable and effective in many scenarios, GNSS suffers from certain weaknesses.

### BRIEF SUMMARY OF EXAMPLE EMBODIMENTS

At least some example embodiments are directed to predicting a path to be taken along a route, and more particularly, to estimating path likelihood using a predictive motion model. Embodiments may provide an apparatus including at least one processor and at least one memory including computer program code, the at least one memory and the computer program code may be configured to, with the processor, cause the apparatus to at least: receive sensor data from an inertial measurement unit associated with a vehicle; determine, from the sensor data, a motion model of the vehicle; retrieve one or more baseline motion models, where each baseline motion model corresponds to a path within an environment along one or more road segments; calculate relative transformations between the motion model of the vehicle and the one or more baseline motion models; identify a predicted motion model of the one or more baseline motion models as corresponding to the vehicle motion model; and determine a path of the vehicle to correspond with the path within the environment corresponding to the predicted motion model.

According to some embodiments, the path within an environment includes at least one road segment of a road network. Causing the apparatus of some embodiments to identify a predicted motion model of the one or more baseline motion models corresponding to the vehicle motion model further includes causing the apparatus to determine an uncertainty of the predicted motion model corresponding to the vehicle motion model. Causing the apparatus of some embodiments to determine a path of the vehicle to correspond with the path within the environment corresponding to the predicted motion model further includes causing the apparatus to determine a map-matched location of the vehicle. Causing the apparatus of some embodiments to determine a path of the vehicle to correspond with the path within the environment corresponding to the predicted motion model further includes causing the apparatus to determine a pose and velocity of the vehicle within the environment. The apparatus of some embodiments is further caused to provide for location based services for the vehicle based on the location of the vehicle. The location based services of an example embodiment include at least one of navigational guidance or at least partial autonomous vehicle control.

Embodiments provided herein include a computer program product including at least one non-transitory computer-readable storage medium having computer-executable program code instructions stored therein, the computer-executable program code instructions including program code instructions to: receive sensor data from an inertial measurement unit associated with a vehicle; determine, from the sensor data, a motion model of the vehicle; retrieve one or more baseline motion models, where each baseline motion model corresponds to a path within an environment along one or more road segments; calculate relative transformations between the motion model of the vehicle and the one or more baseline motion models; identify a predicted motion model of the one or more baseline motion models as corresponding to the vehicle motion model; and determine a path of the vehicle to correspond with the path within the environment corresponding to the predicted motion model.

According to some embodiments, the path within an environment includes at least one road segment of a road network. The program code instructions of some embodiments to identify a predicted motion model of the one or more baseline motion models corresponding to the vehicle motion model further include program code instructions to determine an uncertainty of the predicted motion model corresponding to the vehicle motion model. The program code instructions of some embodiments to determine a path of the vehicle to correspond with the path within the environment corresponding to the predicted motion model further include program code instructions to determine a map-matched location of the vehicle. The program code instructions of some embodiments to determine a path of the vehicle to correspond with the path within the environment corresponding to the predicted motion model further include program code instructions to determine a pose and velocity of the vehicle within the environment. The computer program product of some embodiments further includes program code instructions to provide for location based services for the vehicle based on the location of the vehicle. The location based services of an example embodiment include at least one of navigational guidance or at least partial autonomous vehicle control.

Embodiments provided herein include a method including: receiving sensor data from an inertial measurement unit associated with a vehicle; determining, from the sensor data, a motion model of the vehicle; retrieving one or more baseline motion models, where each baseline motion model corresponds to a path within an environment along one or more road segments; calculating relative transformations between the motion model of the vehicle and the one or more baseline motion models; identifying a predicted motion model of the one or more baseline motion models as corresponding to the vehicle motion model; and determining a path of the vehicle to correspond with the path within the environment corresponding to the predicted motion model.

According to some embodiments, the path within an environment includes at least one road segment of a road network. According to some embodiments, identifying a predicted motion model of the one or more baseline motion models corresponding to the vehicle motion model further includes determining an uncertainty of the predicted motion model corresponding to the vehicle motion model. According to some embodiments, determining a path of the vehicle to correspond with the path within the environment corresponding to the predicted motion model further includes determining a map-matched location of the vehicle. According to certain embodiments, determining a path of the vehicle to correspond with the path within the environment corresponding to the predicted motion model further includes determining a pose and velocity of the vehicle within the environment. The method of some embodiments further includes providing for location based services for the vehicle based on the location of the vehicle. The location based services of an example embodiment include at least one of navigational guidance or at least partial autonomous vehicle control.

Embodiments provided herein include an apparatus including: means for receiving sensor data from an inertial measurement unit associated with a vehicle; means for determining, from the sensor data, a motion model of the vehicle; means for retrieving one or more baseline motion models, where each baseline motion model corresponds to a path within an environment along one or more road segments; means for calculating relative transformations between the motion model of the vehicle and the one or more baseline motion models; means for identifying a predicted motion model of the one or more baseline motion models as corresponding to the vehicle motion model; and means for determining a path of the vehicle to correspond with the path within the environment corresponding to the predicted motion model.

According to some embodiments, the path within an environment includes at least one road segment of a road network. According to some embodiments, the means for identifying a predicted motion model of the one or more baseline motion models corresponding to the vehicle motion model further includes means for determining an uncertainty of the predicted motion model corresponding to the vehicle motion model. According to some embodiments, the means for determining a path of the vehicle to correspond with the path within the environment corresponding to the predicted motion model further includes means for determining a map-matched location of the vehicle. According to certain embodiments, the means for determining a path of the vehicle to correspond with the path within the environment corresponding to the predicted motion model further includes means for determining a pose and velocity of the vehicle within the environment. The apparatus of some embodiments further includes means for providing for location based services for the vehicle based on the location of the vehicle. The location based services of an example embodiment include at least one of navigational guidance or at least partial autonomous vehicle control.

### BRIEF DESCRIPTION OF THE DRAWINGS

Having thus described certain example embodiments in general terms, reference will hereinafter be made to the accompanying drawings, which are not necessarily drawn to scale, and wherein:

FIG. 1 is a block diagram showing an example architecture of an example embodiment described herein;

FIG. 2 is a block diagram of an apparatus that may be specifically configured in accordance with an example embodiment of the present disclosure;

FIG. 3 illustrates an example diagram of an algorithm to correlate a motion model with a vehicle motion model according to an example embodiment of the present disclosure; and

FIG. 4 is a flowchart of a method for estimating path likelihood using a predictive motion model according to an example embodiment of the present disclosure.

### DETAILED DESCRIPTION OF SOME EXAMPLE EMBODIMENTS

Some embodiments will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Methods, apparatus and computer program products are provided in accordance with an example embodiment in order to predict a path to be taken along a route, and more particularly, to estimate path likelihood using a predictive motion model. Embodiments described herein estimate a vehicle location, pose, and velocity based on motion model likelihood with map topology derived motion models. Using road segment and speed information in high-definition maps, and in some embodiments, employing historical or real-time traffic speed along a road, embodiments create motion models for road segments. This calculation can be repeated for each of the connecting links or road segments, such as for all exits of a roundabout. Likelihoods are then calculated for a motion model of a vehicle based on stored motion models. This enhanced dead-reckoning system enables estimation of vehicle location and dead-reckoning parameters accurately for a given road segment and time instance.

Global Navigation Satellite Systems (GNSS) such as the Global Positioning System (GPS) provide useful and relatively accurate indications of locations of devices within a covered environment. However, the accuracy and availability of GNSS services can be adversely affected by a variety of factors. In wide open spaces with adequate GNSS coverage, localization is relatively accurate. However, obstructions between GNSS satellites and the GNSS receiver device introduce localization error. Urban canyons, where GNSS signals are reflected by buildings, can generate substantial localization error. Tree cover can result in lower accuracy coverage. Tunnels can completely shield a receiver from GNSS satellites rendering the system unavailable. Further, there are areas where coverage is less prevalent, such that accuracy can vary widely within such areas. GNSS systems can employ inertial navigation systems (INS) to improve the accuracy of localization. GNSS used with an INS engine provides benefits ranging from bridging GNSS outages to dead-reckoning in urban environments and indoors. The hybrid system also provides stability of the navigation solution in open sky conditions and reduces effects of GNSS signal attenuation and noise. Inertial aiding can also be used when implementing high-precision HDGNSS (High Definition Global Navigation Satellite Systems) solutions in combination with assistance data service.

An INS functions by capturing measurements from an inertial measurement unit (IMU), processing the measurements using equations of motion to calculate a location in the navigation frame. An INS filter estimates the system errors and loops them back to appropriate modules in the system to reduce or cancel the effect of the error. In a ground vehicle use-case, the filter can estimate the vehicle frame orientation with respect to the navigation and body frames. This is particularly important when the sensor unit (body frame) can rotate with respect to the vehicle. In vehicle integrated systems, the misalignment is typically known or at least the error in the IMU pose with respect to the vehicle is small and constant.

The primary error source for an INS is sensor bias which is the steady state sensor offset with zero signal input. A modelling of the other sensor errors is use-case dependent and needs to be considered on case-by-case bases. In high dynamic environments, the contribution of cross-axis errors or g-sensitivity start to affect performance significantly and need to be included into sensor characterization and modeling. The motion sensors behave differently depending on the quality and construction of the sensor. It is also important to consider the operating environment which affects the way sensors react to motion input and changes characteristics of the sensor noise contribution. There is a significant difference between implementing a system using sensors in a mobile device, such as a phone, as compared to a high-end, high-cost platform owing to different motion characteristics and platform vibration.

Sensor error estimation and motion constraints of example embodiments provided herein enable limitations on the degrees of freedom for the solution and provide basis for deriving vehicle frame estimates from the inertial solution. For a ground-based vehicle, motion type is presumed to be non-holonomic, meaning that the vehicle is not sliding or jumping, thereby reducing the y- and z-axis velocities in the vehicle frame to zero. While ground-based vehicles can slide and jump in edge case scenarios, these occurrences are not significant in practice.

High-definition map content with rich object data, as described further below, is becoming more and more common enabling map-matching algorithms to place a vehicle location on a road through object detection and matching using navigation software implementations. High spatial accuracy in the map data allows precision tracking of the vehicle motion up to lane-level in conditions where GNSS hybrid systems can provide real time location and velocity information.

Inertial solutions employed by the INS drift over time when there is no external reference such as GNSS to update the solution. The drift can be the result of velocity estimation error in the filter due to sensor errors and noise among other factors. Dead-reckoning based on high-quality motion sensors and possibly also with vehicle sensor data (e.g., vehicle speed from wheel sensors) can extend the solution to tunnels, but due to sensor errors and errors in pose and velocity estimation, this solution also drifts over time.

Embodiments provided herein obtain vehicle location, pose, and velocity estimation based on motion likelihood with map topology derived motion model. Using road segment and speed information in high-definition maps, a motion model can be created for a connecting link. This calculation can be repeated for each of the connecting links (e.g., for all exits of a roundabout). Likelihood of these motion models can then be calculated for a motion model stored with the dead-reckoning system, enabling embodiments to estimate vehicle location and dead-reckoning parameters accurately for a given road segment and time instance.

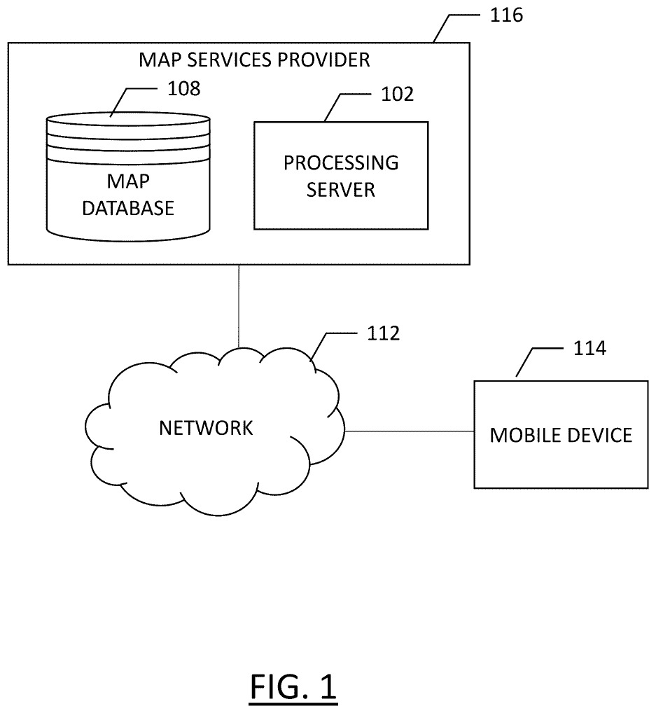

FIG. 1 illustrates a communication diagram of an example embodiment of a system for implementing example embodiments described herein for estimating path, location and pose likelihood using motion models. The illustrated embodiment of FIG. 1 includes a map services provider 116, a processing server 102 in data communication with a geographic map database, e.g., map database 108 through a network 112, and one or more mobile devices 114. The mobile device 114 may be associated, coupled, or otherwise integrated with a vehicle, such as an advanced driver assistance system (ADAS), for example. Additional, different, or fewer components may be provided. For example, many mobile devices 114 may connect with the network 112. The map services provider 116 may include computer systems and a network of a system operator. The processing server 102 may include the map database 108, such as provided by a remote map server. The network may be wired, wireless, or any combination of wired and wireless communication networks, such as cellular, Wi-Fi, internet, local area networks, or the like.

The map database 108 may include node data, road segment data or link data, point of interest (POI) data, or the like. The map database 108 may also include cartographic data, routing data, and/or maneuvering data. The map database 108 can include HD map data as described above. According to some example embodiments, the road segment data records may be links or segments representing roads, streets, or paths, as may be used in calculating a route or recorded route information for determination of one or more personalized routes. The node data may be end points corresponding to the respective links or segments of road segment data. The road link data and the node data may represent a road network, such as used by vehicles, cars, trucks, buses, motorcycles, and/or other entities. Optionally, the map database 108 may contain path segment and node data records or other data that may represent pedestrian paths or areas in addition to or instead of the vehicle road record data, for example. The road/link segments and nodes can be associated with attributes, such as geographic coordinates, street names, address ranges, speed limits, turn restrictions at intersections, and other navigation related attributes, as well as POIs, such as fueling stations, hotels, restaurants, museums, stadiums, offices, auto repair shops, buildings, stores, parks, etc. The map database 108 can include data about the POIs and their respective locations in the POI records. The map database 108 may include data about places, such as cities, towns, or other communities, and other geographic features such as bodies of water, mountain ranges, etc. Such place or feature data can be part of the POI data or can be associated with POIs or POI data records (such as a data point used for displaying or representing a position of a city). In addition, the map database 108 can include event data (e.g., traffic incidents, construction activities, scheduled events, unscheduled events, etc.) associated with the POI data records or other records of the map database 108.

The map database 108 may be maintained by a content provider e.g., a map services provider in association with a services platform. By way of example, the map services provider can collect geographic data to generate and enhance the map database 108. There can be different ways used by the map services provider to collect data. These ways can include obtaining data from other sources, such as municipalities or respective geographic authorities. In addition, the map services provider can employ field personnel to travel by vehicle along roads throughout the geographic region to observe features and/or record information about them, for example. Additional data sources can include OEM vehicles that may provide camera images, camera detections, radar information, LiDAR information, ultrasound information, and/or other sensing technologies. Also, probe data histogram images, aerial imagery, LiDAR data, and dash camera images among others, can be used to generate map geometries directly or through machine learning. The map database 108 may include the digital map data for a geographic region or for an entire mapped space, such as for one or more countries, one or more continents, etc. The map database 108 may partition the mapped space using spatial partitions to segment the space into map tiles that are more manageable than the entire mapped space.

The map database 108 may be a master map database stored in a format that facilitates updating, maintenance, and development. For example, the master map database or data in the master map database can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems including in conjunction with autonomous and semi-autonomous navigation systems.

For example, geographic data may be compiled (such as into a platform specification format (PSF)) to organize and/or configure the data for performing navigation-related functions and/or services, such as route calculation, route guidance, map display, speed calculation, distance and travel time functions, and other functions, by a navigation device, such as by mobile device 114, for example. The navigation-related functions can correspond to vehicle navigation, pedestrian navigation, or other types of navigation. The compilation to produce the end user databases can be performed by a party or entity separate from the map services provider. For example, a customer of the map services provider, such as a navigation services provider or other end user device developer, can perform compilation on a received map database in a delivery format to produce one or more compiled navigation databases.

As mentioned above, the server side map database 108 may be a master geographic database, but in alternate embodiments, a client side map database 108 may represent a compiled navigation database that may be used in or with end user devices (e.g., mobile device 114) to provide navigation and/or map-related functions. For example, the map database 108 may be used with the mobile device 114 to provide an end user with navigation features. In such a case, the map database 108 can be downloaded or stored on the end user device (mobile device 114) which can access the map database 108 through a wireless or wired connection, such as via a processing server 102 and/or the network 112, for example.

In certain embodiments, the end user device or mobile device 114 can be an in-vehicle navigation system, such as an ADAS, a personal navigation device (PND), a portable navigation device, a cellular telephone, a smart phone, a personal digital assistant (PDA), a watch, a camera, a computer, and/or other device that can perform navigation-related functions, such as digital routing and map display. End user devices may optionally include automated computer systems, such as map data service provider systems and platforms as the map may be processed, utilized, or visualized via one or more other computing systems. An end user can use the mobile device 114 for navigation and map functions such as guidance and map display, for example, and for determination of one or more personalized routes or route segments based on one or more calculated and recorded routes, according to some example embodiments.

An ADAS, as described herein, may be used to improve the comfort, efficiency, safety, and overall satisfaction of driving. Examples of such advanced driver assistance systems include semi-autonomous driver assistance features such as adaptive headlight aiming, adaptive cruise control, lane departure warning and control, curve warning, speed limit notification, hazard warning, predictive cruise control, adaptive shift control, among others. Other examples of an ADAS may include provisions for fully autonomous control of a vehicle to drive the vehicle along a road network without requiring input from a driver. Some of these advanced driver assistance systems use a variety of sensor mechanisms in the vehicle to determine the current state of the vehicle and the current state of the roadway ahead of the vehicle. These sensor mechanisms may include radar, infrared, ultrasonic, and vision-oriented sensors such as image sensors and light distancing and ranging (LiDAR) sensors.

Some advanced driver assistance systems may employ digital map data. Such systems may be referred to as map enhanced ADAS. The digital map data can be used in advanced driver assistance systems to provide information about the road network, road geometry, road conditions, and other information associated with the road and environment around the vehicle. Unlike some sensors, the digital map data is not affected by the environmental conditions such as fog, rain, or snow. Additionally, the digital map data can provide useful information that cannot reliably be provided by sensors, such as curvature, grade, bank, speed limits that are not indicated by signage, lane restrictions, and so on. Further, digital map data can provide a predictive capability well beyond the driver's vision to determine the road ahead of the vehicle, around corners, over hills, or beyond obstructions. Accordingly, the digital map data can be a useful and sometimes necessary addition for some advanced driving assistance systems. In the example embodiment of a fully autonomous vehicle, the ADAS uses the digital map data to determine a path along the road network to drive, such that accurate representations of the road are necessary, such as accurate representations of intersections and turn paths there through.

While the mobile device 114 may be used by an end-user for navigation, driver assistance, autonomous or semi-autonomous vehicle control, or various other features, the mobile device 114 may provide map data to the map services provider 116 for purposes of updating, building, restoring, or repairing the map database 108, for example. The processing server 102 may receive probe data from a mobile device 114. The mobile device 114 may include one or more detectors or sensors as a positioning system built or embedded into or within the interior of the mobile device 114. Alternatively, the mobile device 114 uses communications signals for position determination. The mobile device 114 may receive location data from a positioning system, such as a global positioning system (GPS), cellular tower location methods, access point communication fingerprinting, or the like. The server 102 may receive sensor data configured to describe a position of a mobile device, or a controller of the mobile device 114 may receive the sensor data from the positioning system of the mobile device 114. The mobile device 114 may also include a system for tracking mobile device movement, such as rotation, velocity, or acceleration. Movement information may also be determined using the positioning system. The mobile device 114 may use the detectors and sensors to provide data indicating a location of a vehicle. This vehicle data, also referred to herein as “probe data,” may be collected by any device capable of determining the necessary information, and providing the necessary information to a remote entity. The mobile device 114 is one example of a device that can function as a probe to collect probe data of a vehicle.

More specifically, probe data (e.g., collected by mobile device 114) is representative of the location of a vehicle at a respective point in time and may be collected while a vehicle is traveling along a route. The probe data may also include speed and direction in some embodiments, such as when probe data is used to facilitate vehicle traffic speed determination. According to the example embodiment described below with the probe data being from motorized vehicles traveling along roadways, the probe data may include, without limitation, location data, (e.g. a latitudinal, longitudinal position, and/or height, GPS coordinates, cartesian coordinates, proximity readings associated with a radio frequency identification (RFID) tag, or the like), rate of travel, (e.g. speed), direction of travel, (e.g. heading, cardinal direction, or the like), device identifier, (e.g. vehicle identifier, user identifier, or the like), a time stamp associated with the data collection, or the like. The mobile device 114, may be any device capable of collecting the aforementioned probe data. Some examples of the mobile device 114 may include specialized vehicle mapping equipment, navigational systems, mobile devices, such as phones or personal data assistants, or the like.

While probe data ideally includes accurate location information, that information is not always readily available. GNSS localization can be limited in certain environments, and may not be available in some areas. As such, the probe data may not have a conventional source to identify the location of the mobile device or vehicle. Embodiments described herein capitalize on sensor data from other sensors to establish a location estimate using stored mobility models. To do this, embodiments use acceleration, heading, and velocity to model the movement of the vehicle along a road segment. That generated model is compared against stored mobility models to identify a road segment that has a corresponding model. Based on models matching within a predetermined degree of similarity, the road segment corresponding to the stored model is established as the road segment along which the vehicle is traveling.

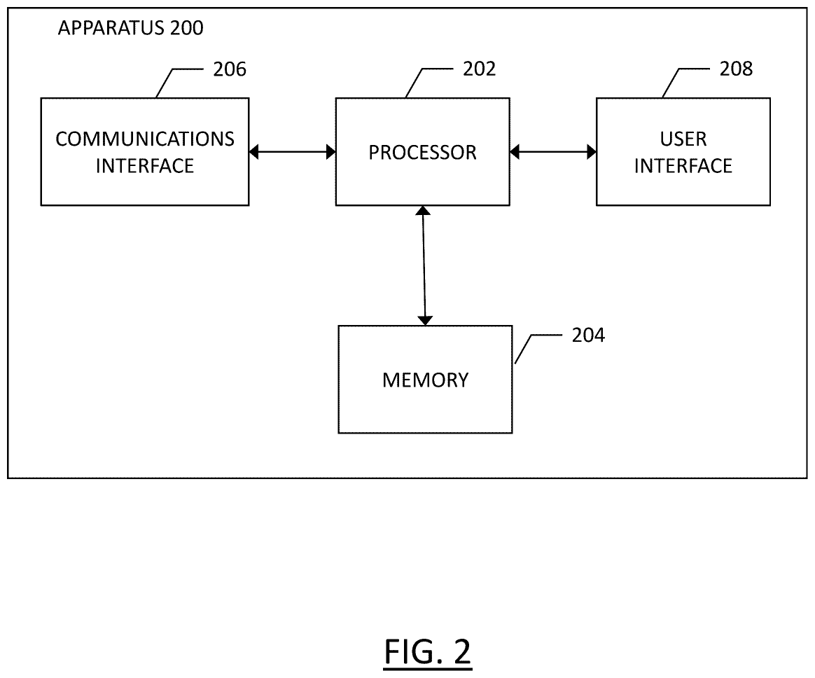

An example embodiment of a processing server 102 may be embodied in an apparatus as illustrated in FIG. 2. The apparatus, such as that shown in FIG. 2, may be specifically configured in accordance with an example embodiment of the present disclosure for revising map geometry based on a detailed analysis of probe data and existing map geometry. The apparatus may include or otherwise be in communication with a processor 202, a memory device 204, a communication interface 206, and a user interface 208. In some embodiments, the processor (and/or co-processors or any other processing circuitry assisting or otherwise associated with the processor) may be in communication with the memory device via a bus for passing information among components of the apparatus. The memory device may be non-transitory and may include, for example, one or more volatile and/or non-volatile memories. In other words, for example, the memory device may be an electronic storage device (for example, a computer readable storage medium) comprising gates configured to store data (for example, bits) that may be retrievable by a machine (for example, a computing device like the processor 202). The memory device may be configured to store information, data, content, applications, instructions, or the like, for enabling the apparatus to carry out various functions in accordance with an example embodiment of the present disclosure. For example, the memory device could be configured to buffer input data for processing by the processor. Additionally or alternatively, the memory device could be configured to store instructions for execution by the processor.

The processor 202 may be embodied in a number of different ways. For example, the processor may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. Embodiments described herein can further employ a processer embodied by a Graphics Processing Unit (GPU) specifically configured for neural network implementations and/or image processing capitalizing on efficient processing capabilities using multiple parallel operations. As such, in some embodiments, the processor may include one or more processing cores configured to perform independently. A multi-core processor may enable multiprocessing within a single physical package. Additionally or alternatively, the processor may include one or more processors configured in tandem via the bus to enable independent execution of instructions, pipelining and/or multithreading.

In an example embodiment, the processor 202 may be configured to execute instructions stored in the memory device 204 or otherwise accessible to the processor. Alternatively or additionally, the processor may be configured to execute hard coded functionality. As such, whether configured by hardware or software methods, or by a combination thereof, the processor may represent an entity (for example, physically embodied in circuitry) capable of performing operations according to an embodiment of the present disclosure while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor specific device (for example, a mobile terminal or a fixed computing device) configured to employ an embodiment of the present disclosure by further configuration of the processor by instructions for performing the algorithms and/or operations described herein. The processor may include, among other things, a clock, an arithmetic logic unit (ALU) and logic gates configured to support operation of the processor.

The apparatus 200 of an example embodiment may also include a communication interface 206 that may be any means such as a device or circuitry embodied in either hardware or a combination of hardware and software that is configured to receive and/or transmit data to/from a communications device in communication with the apparatus, such as to facilitate communications with one or more mobile devices 114 or the like. In this regard, the communication interface may include, for example, an antenna (or multiple antennae) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired communication. As such, for example, the communication interface may include a communication modem and/or other hardware and/or software for supporting communication via cable, digital subscriber line (DSL), universal serial bus (USB) or other mechanisms.

The apparatus 200 may also include a user interface 208 that may, in turn be in communication with the processor 202 to provide output to the user and, in some embodiments, to receive an indication of a user input. As such, the user interface may include a display and, in some embodiments, may also include a keyboard, a mouse, a joystick, a touch screen, touch areas, soft keys, one or more microphones, a plurality of speakers, or other input/output mechanisms. In one embodiment, the processor may comprise user interface circuitry configured to control at least some functions of one or more user interface elements such as a display and, in some embodiments, a plurality of speakers, a ringer, one or more microphones and/or the like. The processor and/or user interface circuitry comprising the processor may be configured to control one or more functions of one or more user interface elements through computer program instructions (for example, software and/or firmware) stored on a memory accessible to the processor (for example, memory device 204, and/or the like).

Embodiments described herein use a predictive motion model to propagate vehicle motion through a particular road segment pattern. This pattern can be a drive through a particular path, such as through a roundabout, forming a specific type of motion model. This model can include vehicle coordinates along the road segments and associated pose and velocity predictions. The model described herein considers vehicle behavior including a velocity profile and can incorporate parameters such as driving comfort to estimate the most probably driving motion model for a given road segment. The motion model creation is repeated for each of the connecting links, such as all of the road links emanating from a roundabout.

The vehicle dead reckoning system described herein stores its own estimate of the motion to create similar relative motion models. The algorithm of example embodiments then estimates likelihoods of the stored motion model and the predicted motion model representing the same motion trajectory. This likelihood estimation may take form of hand-eye calibration, a correlation process, a path fitting (fitting one motion model to a measured motion model), or a root mean square (RMS) error minimizing problem as examples of potential algorithmic approaches.

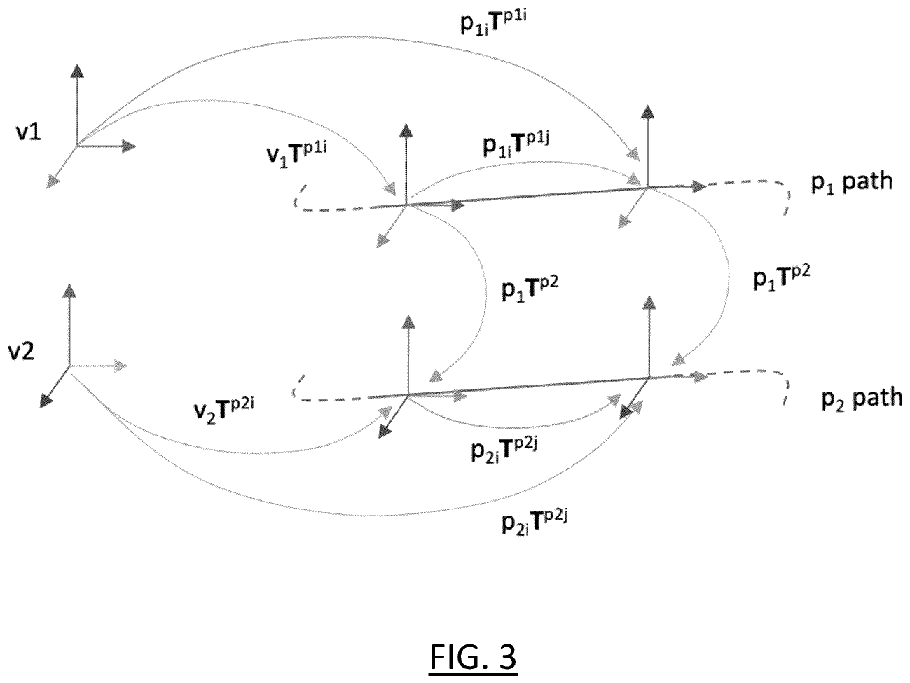

Even in a case of the dead reckoning system misestimating the absolute pose and velocity values, the relative changes are typically better estimated and can be used in motion model creation. FIG. 3 illustrates an example implementation of an algorithm described herein. As shown, v1 is the vehicle pose estimate, v2 is the model predicted pose. Further, p1 is real vehicle motion model and p2 the predicted motion model. T (4×4) matrices represent pose change from point I to point j and between paths.

According to example embodiments, motion models are precalculated using vehicle motion model generation means and HD map data. These motion models reflect how a vehicle would perform along a respective path, with acceleration, velocity, and pose/heading considered. These motion models can factor in curvatures in the roadway, banking, traffic speeds, undulations, etc. to closely model how a vehicle performs along any given road segment. A vehicle location can be initially estimated through any available means, which can include GNSS, signal fingerprinting, nearby devices or access points/beacons. Understanding an initial position can help reduce the potential motion models that are considered when map-matching a vehicle to a road segment based on the motion of the vehicle. The sensors of the vehicle sense motion, heading, etc. and a processor, such as processor 202, calculates relative transformation between vehicle and modelled poses. This becomes the hand-eye calibration problem of AX=BX. In the AX=BX problem, A is the transformation between two different positions of the vehicle, and B is the transformation between two different positions in a motion model that is stored, such as in map database 108. X is the unknown that is sought.

The estimation process can be resource intensive, such that embodiments can employ strategies to mitigate the processing requirements. Understanding an initial location can help reduce the number of motion models that are considered to match to the vehicle motion. Further, there can be a triggering criteria to initiate the process described herein such that it is not continuously running. One potential trigger is the estimation and motion model creation process being triggered by a key motion indicator, such as a vehicle heading rate exceeding a predetermined limit, indicating a motion through an intersection, turn, or roundabout for example.

Comparing the vehicle motion to stored motion models aims to find the most probable path. Once the most probable path is found, the dead reckoning solution is updated with one or more of location, pose, and velocity. The information can be taken from the predicted path model for a given time instance or it can be derived during the fitting process to represent merged estimates. The approach taken depends on the dead reckoning system quality and the current pose prediction uncertainty. In case the dead reckoning system still has high confidence in its solution, the update can be weighted toward it. If the dead reckoning solution has diverged, the update may come solely from the prediction model. The update can be weighted for the update, or the dead reckoning can be reinitialized or realigned to the given point. The optimal approach may rely on a hybrid filter implementation.

The motion model prediction described herein can include uncertainty estimates for each of the prediction points. These uncertainty estimates can be used in weighting for the fitting (likelihood estimation) and can improve a filter update step by providing an improved error model. To compensate for processing delay, the pose estimates can be backpropagated to the correct time instance allowing the correct filter alignment.

Determining a location without conventional localization services (e.g., GNSS) is challenging. Pure dead reckoning localization generally drifts over time and can result in significant location errors as travel distances increase. Embodiments of the present disclosure provide a mechanism that can be used independently, or in addition to dead reckoning. Further, embodiments can be used in conjunction with conventional localization services.

A motion model database can be generated in a variety of ways. Using HD map data in a map database (e.g., map database 108), a deep understanding of road segments is available. Road properties such as road incline, curvature, banking, speed bumps, etc. can be available in HD map data, along with properties such as speed limits, stop signs, traffic lights, etc. Additionally, HD map data can include historical, real-time, or predicted traffic speeds on road segments. This information can be used for generating a motion model for a road segment that reflects how a vehicle would perform on the respective road segment. Alternatively or in addition to this method of generating and updating a motion model database, real-world vehicle performance can be crowd-sourced or generated by vehicles actually traversing a road segment. This can be particularly useful when HD map data is incomplete or of low confidence. Vehicles traveling a road segment can provide motion model information regarding that road segment, particularly if they also have localization data, such as data from GNSS or other verifiable localization means. Further, generative artificial intelligence can be employed to determine motion models for road segments based on HD map data for a road segment. Through one or more of these mechanisms, a database of motion models for a road network can be generated.

Vehicle sensors of a vehicle traveling along a road segment can collect a variety of data relating to operation of the vehicle. Gyroscopic data or data from an inertial measurement unit (which can include gyroscopes, accelerometers, magnetometers, etc.) can provide an indication of a vehicle traveling around a curve or through a turn, which can indicate in a curvature or intersection, respectively, within a road network. A speed bump sensed by accelerometers of a vehicle can provide a specific localization indication for a motion model that includes a speed bump, particularly when it is rare in a particular area. The speed of a vehicle traveling in an area can also provide an indication of location. For example, a highway with an adjacent service road may have very similar motion models in general with heading and turns coinciding; however, a speed well in excess of the speed limit on the service road may provide a strong indication that a vehicle is traveling on the highway.

Motion models can serve as fingerprints for a road segment, where each road segment has a specific fingerprint. Some motion models may be very similar, such as consecutive road segments along a highway. In such cases, the general road may be known, but a position along that highway may not be well known until such time as a turn is made, traffic slows, or other defining characteristic of the vehicle motion model. A vehicle motion model generated from sensor data of a vehicle can produce a fingerprint, and embodiments described herein match the vehicle motion model to a predefined motion model stored in a database to correlate the location of a vehicle with a known location of a predefined motion model.

Correlating vehicle motion models with stored, predefined motion models can be imprecise. Vehicle motion may differ between different trips along a road segment and along a given route. Traffic speeds can cause variation, lane changes can result in additional detected lateral acceleration, braking for an object in the road can be difficult to replicate, and a variety of other factors can result in vehicle motion models that fail to exactly correlate to stored motion models. As such, vehicle motion models can be correlated with stored motion models to identify a predicted motion model using a similarity metric.

As detailed above, motion models may include a variety of types of sensor data. Each of the types of sensor data present in a vehicle motion model may be compared against stored motion model data. The amount of similar data between the motion models may be used to rank which stored motion model best correlates with the vehicle motion model. The stored motion models may be ranked from most similar to least similar. The most similar motion model may generally be selected as the predicted motion model to correspond with the vehicle motion model. However, if no stored motion model satisfies a predetermined degree of similarity (e.g., 80% similarity), the vehicle motion model may not be correlated to any stored motion model. This helps mitigate false positive correlations. According to some embodiments, the correlated motion model may be identified with a score, where the score provides a likelihood of accuracy of that motion model corresponding to the vehicle motion model.

Embodiments described herein identify a predicted motion model from a set of candidate motion models that best matches the sensor recorded motion model of a vehicle. As a vehicle collects motion data, that motion data forms a sensor recorded motion model. That motion model can be compared against a plurality of candidate motion models to establish a best match, which is then identified as the predicted motion model. The candidate motion models including the predicted motion model are each associated with a geographic location, such that matching the sensor recorded motion model with the predicted motion model identifies a location of the vehicle based on the sensor recorded data. The “best match” can be established based on a variety of matching algorithms. For example, the best match can be the candidate motion model that most closely follows the sensor recorded motion model along the duration of the sensor recorded motion model. Optionally, the best match can be established based on peak sensor readings of a sensor recorded motion model corresponding with those of a particular candidate motion model. Various matching processes can be used to identify the “best match” and thus to select a candidate motion model as a predicted motion model.

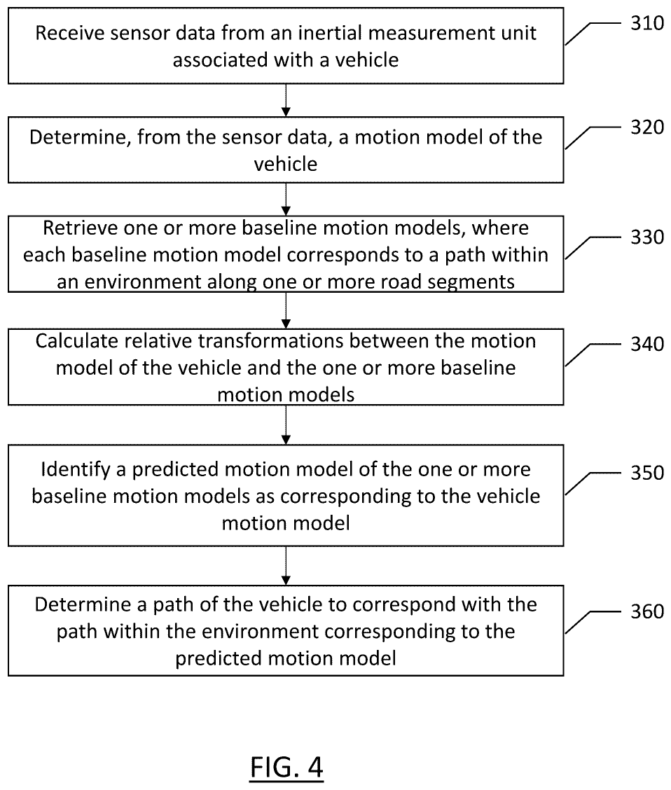

FIG. 4 illustrates a flowchart of a method for predicting a path to be taken along a route, and more particularly, to estimating path likelihood using a predictive motion model. As shown at 310, sensor data from an inertial measurement unit associated with a vehicle is received. From the sensor data, a motion model of the vehicle is determined at 320. One or more baseline motion models are retrieved at 330, where each baseline motion model corresponds to a path within an environment along one or more road segments. Relative transformations are calculated between the motion model of the vehicle and the one or more baseline motion models at 340. A predicted motion model of the one or more baseline motion models is identified at 350 as corresponding to the vehicle motion model. A path of the vehicle is determined to correspond with the path within the environment corresponding to the predicted motion model at 360.

As described above, FIG. 4 illustrates a flowchart of apparatuses 200, methods, and computer program products according to an example embodiment of the disclosure. It will be understood that each block of the flowchart, and combinations of blocks in the flowchart, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by the memory device 204 of an apparatus employing an embodiment of the present invention and executed by the processor 202 of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In an example embodiment, an apparatus for performing the method of FIG. 4 above may comprise a processor (e.g., the processor 202) configured to perform some or each of the operations (310-360) described above. The processor may, for example, be configured to perform the operations (310-360) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 310-360 may comprise, for example, the processor 202 and/or a device or circuit for executing instructions or executing an algorithm for processing information as described above.

In some embodiments, certain ones of the operations above may be modified or further amplified. Furthermore, in some embodiments, additional optional operations may be included. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. An apparatus comprising at least one processor and at least one memory including computer program code, the at least one memory and the computer program code configured to, with the processor, cause the apparatus to at least:
receive sensor data from an inertial measurement unit associated with a vehicle;
determine, from the sensor data, a motion model of the vehicle;
retrieve one or more baseline motion models, wherein each baseline motion model corresponds to a path within an environment along one or more road segments;
calculate relative transformations between the motion model of the vehicle and the one or more baseline motion models;
identify a predicted motion model of the one or more baseline motion models as corresponding to the vehicle motion model; and
determine a path of the vehicle to correspond with the path within the environment corresponding to the predicted motion model.

2. The apparatus of claim 1, wherein the path within an environment comprises at least one road segment of a road network.

3. The apparatus of claim 1, wherein causing the apparatus to identify a predicted motion model of the one or more baseline motion models as corresponding to the vehicle motion model further comprises causing the apparatus to determine an uncertainty of the predicted motion model corresponding to the vehicle motion model.

4. The apparatus of claim 1, wherein causing the apparatus to determine a path of the vehicle to correspond with the path within the environment corresponding to the predicted motion model further comprises causing the apparatus to determine a map-matched location of the vehicle.

5. The apparatus of claim 4, wherein causing the apparatus to determine a path of the vehicle to correspond with the path within the environment corresponding to the predicted motion model further comprises causing the apparatus to determine a pose and velocity of the vehicle within the environment.

6. The apparatus of claim 4, wherein the apparatus is further caused to provide for location based services for the vehicle based on the location of the vehicle.

7. The apparatus of claim 6, wherein the location based services comprise at least one of navigational guidance or at least semi-autonomous vehicle control.

8. A computer program product comprising at least one non-transitory computer-readable storage medium having computer-executable program code instructions stored therein, the computer-executable program code instructions comprising program code instructions to:
receive sensor data from an inertial measurement unit associated with a vehicle;
determine, from the sensor data, a motion model of the vehicle;
retrieve one or more baseline motion models, wherein each baseline motion model corresponds to a path within an environment along one or more road segments;
calculate relative transformations between the motion model of the vehicle and the one or more baseline motion models;
identify a predicted motion model of the one or more baseline motion models as corresponding to the vehicle motion model; and
determine a path of the vehicle to correspond with the path within the environment corresponding to the predicted motion model.

9. The computer program product of claim 8, wherein the path within an environment comprises at least one road segment of a road network.

10. The computer program product of claim 8, wherein the program code instructions to identify a predicted motion model of the one or more baseline motion models as corresponding to the vehicle motion model further comprises program code instructions to determine an uncertainty of the predicted motion model corresponding to the vehicle motion model.

11. The computer program product of claim 8, wherein the program code instructions to determine a path of the vehicle to correspond with the path within the environment corresponding to the predicted motion model further comprises program code instructions to determine a map-matched location of the vehicle.

12. The computer program product of claim 11, wherein the program code instructions to determine a path of the vehicle to correspond with the path within the environment corresponding to the predicted motion model further comprises program code instructions to determine a pose and velocity of the vehicle within the environment.

13. The computer program product of claim 11, further comprising program code instructions to provide for location based services for the vehicle based on the location of the vehicle.

14. The computer program product of claim 13, wherein the location based services comprise at least one of navigational guidance or at least semi-autonomous vehicle control.

15. A method comprising:
receiving sensor data from an inertial measurement unit associated with a vehicle;
determining, from the sensor data, a motion model of the vehicle;
retrieving one or more baseline motion models, wherein each baseline motion model corresponds to a path within an environment along one or more road segments;
calculating relative transformations between the motion model of the vehicle and the one or more baseline motion models;
identifying a predicted motion model of the one or more baseline motion models as corresponding to the vehicle motion model; and
determining a path of the vehicle to correspond with the path within the environment corresponding to the predicted motion model.

16. The method of claim 15, wherein the path within an environment comprises at least one road segment of a road network.

17. The method of claim 15, wherein identifying a predicted motion model of the one or more baseline motion models as corresponding to the vehicle motion model further comprises determining an uncertainty of the predicted motion model corresponding to the vehicle motion model.

18. The method of claim 15, wherein determining a path of the vehicle to correspond with the path within the environment corresponding to the predicted motion model further comprises determining a map-matched location of the vehicle.

19. The method of claim 18, wherein determining a path of the vehicle to correspond with the path within the environment corresponding to the predicted motion model further comprises determining a pose and velocity of the vehicle within the environment.

20. The method of claim 18, wherein the apparatus is further caused to provide for location based services for the vehicle based on the location of the vehicle.
